(19) United States
(12) Patent Application Publication
(10) Pub. No.: US 2007/0181160 A1
(43) Pub. Date: Aug. 9, 2007

(54) SUPPORTER AND APPARATUS FOR CLEANING SUBSTRATES WITH THE SUPPORTER, AND METHOD FOR CLEANING SUBSTRATES

(75) Inventors: Hun-Jung YI, Gyeonggi-do (KR); Yong-Kyun KO, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/671,978

(22) Filed: Feb. 6, 2007

(30) Foreign Application Priority Data
Feb. 6, 2006 (KR) 2006-0011326

(51) Int. Cl. B08B 9/20; B08B 3/00

(52) U.S. Cl. 134/25.1; 134/61

(57) ABSTRACT

Provided are a supporter and a substrate cleaning apparatus including the supporter, and a method for cleaning substrates. In the apparatus, a guide plate is provided close to an outer surface of an outermost substrate among substrates arranged in a cleaning process. The guide plate is shaped such that cleaning liquid injected toward a lower edge of the outermost substrate flows to an upper edge of the outermost substrate in a substantially vertical direction.

### CROSS-REFERENCE TO RELATED APPLICATIONS

This U.S. non-provisional patent application claims priority under 35 U.S.C. §119 to Korean Patent Application No. 2006-11326 filed on Feb. 6, 2006, the entire contents of which are hereby incorporated by reference.

### BACKGROUND

1. Technical Field

The invention disclosed herein relates to an apparatus for manufacturing a semiconductor device, and more particularly, to an apparatus and method for cleaning semiconductor substrates.

2. Description of the Related Art

Generally, semiconductor devices are manufactured by repeating deposition, photolithography, etching, polishing, and cleaning processes. The cleaning process is performed after each of the other processes to remove residual chemicals, small particles, contaminants, or unnecessary layers from semiconductor wafers. Since recent semiconductor wafers are formed with much smaller patterns, the cleaning process is much more important than before.

A cleaning process of a semiconductor wafer includes a chemical solution treatment process for etching away or striping contaminants from the semiconductor wafer by means of chemical reactions, a rinsing process for rinsing the chemically treated semiconductor wafer with deionized water, and a drying process for drying the rinsed semiconductor wafer.

In a conventional cleaning process, a spin dryer dries wafers one by one using a centrifugal force. However, the spin dryer decreases the productivity of semiconductor manufacturing since it dries wafers one by one. To eliminate this problem, a batch type dryer is recently developed in which a plurality of wafers is dipped into cleaning liquid and then is dried at once.

A batch type dryer includes a treating room in which cleaning liquid is filled, a supporter disposed in the treating room for supporting wafers, and nozzles disposed under the supporter for supplying cleaning liquid to the wafers. FIG. 1 is a perspective view of a conventional supporter 900. Referring to FIG. 1, the supporter 900 includes supporting rods 920 and fixing plates 940. The supporting rods 920 are formed with slots for receiving edges of wafers, and the fixing plates 940 connect ends of the supporting rods 920 and are used to fix the supporter 900 to a treating room during a process. Each of the fixing plates 940 includes a connecting plate 942 formed at a lower portion for connecting the supporting rods 920 and an elongated fixing rod 944 extending upwardly from the connecting plate 942.

FIG. 2 illustrates flow paths of cleaning liquid supplied to a wafer (W) when the supporter 900 is used. The flow of the cleaning liquid encounters larger resistance between the fixing rod 944 and the wafer (W) facing the fixing rod 944 than other regions. In the conventional supporter 900, the width of the fixing rod 944 is small, such that cleaning liquid supplied between the fixing rod 944 and the wafer (W) easily diverges outwardly from the fixing rod 944. Therefore, cleaning liquid cannot be sufficiently supplied to a center region of the wafer (W) facing the fixing rod 944. Consequently, the center region of the outmost wafer (W) (particularly, the upper region of the center region) is not sufficiently cleaned when compared with other regions of the wafer (W). An apparatus and method for cleaning wafers that ensures adequate fluid flow between a fixing rod and a wafer is thus desired.

### SUMMARY

The invention provides an apparatus and method for cleaning substrates, in which outermost substrates (wafers) can be more efficiently cleaned. A guide plate disposed between an outermost wafer and a fixing rod ensures that cleaning chemicals flow substantially vertically across the surface of the outermost wafer.

### BRIEF DESCRIPTION OF THE FIGURES

Non-limiting and non-exhaustive embodiments of the invention will be described with reference to the following figures, wherein like reference numerals refer to like parts throughout the various figures unless otherwise specified. In the figures:

FIG. 1 is a perspective view of a conventional supporter;

FIG. 2 illustrates flow paths of cleaning liquid supplied to a wafer when the supporter of FIG. 1 is used;

FIGS. 3 and 4 are cross sectional views illustrating a substrate cleaning apparatus according to an embodiment of the invention;

FIG. 5 is a perspective view illustrating a supporter of the substrate cleaning apparatus depicted in FIG. 3, according to an embodiment of the invention;

FIG. 6 is a side view of the supporter depicted in FIG. 5;

FIGS. 7 and 8 are views illustrating flow paths of cleaning liquid comparing the case where the supporter of FIG. 1 is used and the case where the supporter of FIG. 5 is used; and

FIG. 9 shows a process error resulting from the use of the supporter of FIG. 1.

### DETAILED DESCRIPTION OF EXAMPLE EMBODIMENTS

Preferred embodiments of the invention will be described below in more detail with reference to the accompanying drawings. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity.

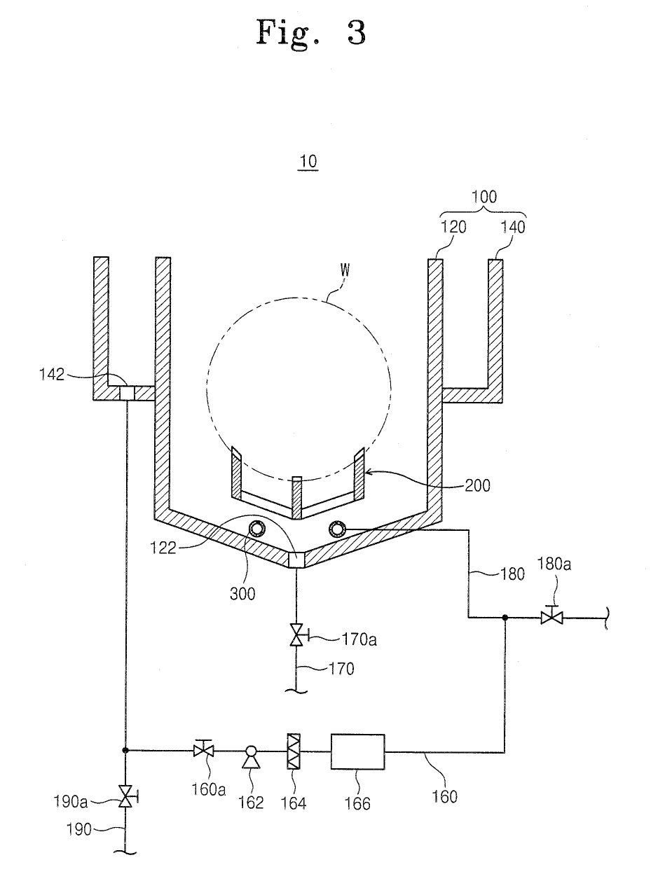

Hereinafter, will be described embodiments of the invention in conjunction with FIGS. 3 through 9.

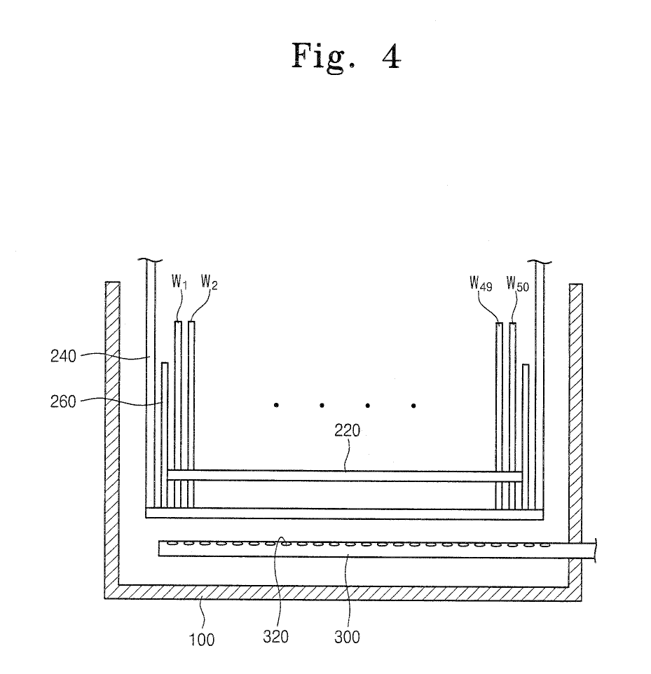

FIGS. 3 and 4 are cross sectional views schematically illustrating a substrate cleaning apparatus 10 according to an embodiment of the invention. The substrate cleaning apparatus 10 performs cleaning on a plurality of wafers (W). Referring to FIGS. 3 and 4, the substrate cleaning apparatus 10 includes a treating room 100, a supporter 200, and a liquid supplying member. The treating room 100 accommodates wafers (W) and provides a processing room for the wafers (W). The supporter 200 supports the wafers (W) in the treating room 100. The liquid supplying member supplies cleaning liquid into the treating room 100.

For example, the cleaning liquid may be rinsing liquid such as deionized water for removing remaining chemical solutions from the wafers (W). Further, the cleaning liquid may be a chemical solution, such as a phosphate solution, a hydrofluoric solution, a sulfuric (H₂SO₄) solution, or an ammonium hydroxide solution, for removing contaminants such as remaining films, organic substances, or particles from the wafers (W).

The current embodiment describes an apparatus that removes remaining films or contaminants from wafers (W) using a chemical solution such as a H₂SO₄ solution. For example, the remaining film may be a photoresist. The above-described elements will now be more fully described.

The treating room 100 includes an inner tub 120 with an opened top and an outer tub 140 surrounding the inner tub 120 to receive cleaning liquid overflowing from the inner tub 120. The inner tub 120 includes a drain hole 122 in a bottom surface to discharge the cleaning liquid from the inner tub 120. A drain tube 170 having a valve 170a is connected to the drain hole 122. The outer tub 140 includes a drain hole 142 in a bottom surface to discharge the cleaning liquid from the outer tub 140. A drain tube 190 having a valve 190a is connected to the drain hole 142.

The liquid supplying member supplies cleaning liquid to the inner tub 120. The liquid supplying member includes a nozzle 300. Two or more nozzles 300 can be included in the liquid supplying member. Each of the nozzles 300 has a rod shape and is disposed in the inner tub 120. Each of the nozzles 300 is formed with a plurality of injection holes 320 arranged in a lengthwise direction. A liquid supplying tube 180 is connected to the nozzles 300 to supply cleaning liquid from a cleaning liquid reservoir (not shown) to the nozzles 300.

A valve 180a is installed in the liquid supplying tube 180 to close/open the liquid supplying tube 180 or adjust the flow rate of the cleaning liquid flowing through the liquid supplying tube 180. Further, a recirculating tube 160 branches off from the drain tube 190 and connects to the liquid supplying tube 180. A valve 160a is installed in the recirculating tube 160 for opening and closing. Cleaning liquid discharged from the inner tub 120 is supplied again to the inner tub 120 through the recirculating tube 160 and the liquid supplying tube 180. A pump 162, a filter 164, and a heater 166 are installed at the recirculating tube 160. The pump 162 forces the cleaning liquid from the drain tube 190 to the supplying tube 180, and the filter 164 removes foreign substances from the recirculating cleaning liquid. The heater 166 heats the recirculating liquid to a process temperature of the inner tub 120.

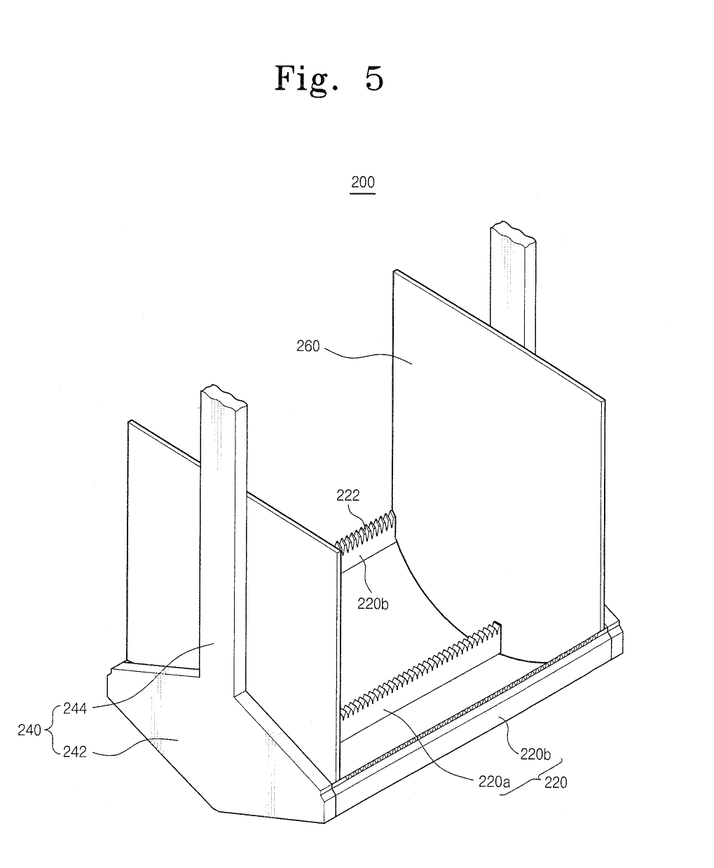

The supporter 200 is disposed in the inner tub 120 to support wafers (W) during a cleaning process. Referring to FIG. 5, the supporter 200 includes supporting rods 220, fixing plates 240, and guide plates 260. Each of the supporting rods 220 has an elongated shape and is formed with slots 222 along a lengthwise direction to receive edges of wafers (W). The number of the slots 222 may be fifty. However, the number of the slots 222 is not limited to fifty. The supporting rods 220 are formed in parallel to each other. For example, the supporter 200 includes a central supporting rod 220a receiving lower edges of wafers (W), and two side supporting rods 220b spaced a predetermined distance from the central supporting rod 220a. Owing to this structure of the supporter 200, wafers (W) can be arranged on the supporter 200 in a row in an upright position during a cleaning process. Hereinafter, the slots 222 will be referred to as a first slot, a second slot, etc, up to a fiftieth slot in the order of formation. A wafer (W) inserted in the first slot will be referred to as a first wafer W₁, a wafer (W) inserted in the second slot will be referred to as a second wafer W₂, and so on. Further, the slots 222 into which wafer W₁ and W₅₀ are inserted may be referred to as end slots, while the slots 222 into which wafers W₂-W₄₉ are inserted may be referred to as interior slots. According to some embodiments, the W₁ slot may be referred to as a first end slot and the W₅₀ slot may be referred to as a second end slot.

The fixing plates 240 are formed on both sides of the supporting rods 220 to connect the supporting rods 220 and fix the supporter 200 to the treating room 100. Each of the fixing plates 240 includes a connecting plate 242 to which ends of the supporting rods 200 are fixed, and an elongated fixing rod 244 upwardly extending from the connecting plate 242 for being fixed to the treating room 100. Alternatively, instead of being fixed to the treating room 100, the supporter 200 can be moved up and down by a lifting unit (not shown).

In operation, cleaning liquid is injected from the nozzles 300 to wafers (W). The injected cleaning liquid flows upward from a lower portion of the supporter 200 along surfaces of the wafers (W). Both sides of the second wafer W₂ through the forty-ninth wafer W₄₉ and inner sides of the first wafer W₁ and the fiftieth wafer W₅₀ are under substantially the same cleaning conditions since they face each other. However, outer sides of the first wafer W₁ and the fiftieth wafer W₅₀ are under different cleaning conditions.

The guide plates 260 guide flow of cleaning liquid, such that the outer sides of the outermost wafers W₁ and W₅₀ can be cleaned under the same cleaning conditions as the inner sides of the outermost wafers W₁ and W₅₀ and both sides of the other wafers W₂ to W₄₉. Referring again to FIG. 5, the guide plates 260 are fixed to the supporting rods 220. One of the guide plates 260 is disposed between the first wafer W₁ inserted into the first slot and the fixing plate 240, and the other is disposed between the fiftieth wafer W₅₀ and the fixing plate 240. According to some embodiments, the guide plate 260 disposed next to W₁ may be referred to as a first guide plate and the guide plate 260 disposed next to W₅₀ may be referred to as a second guide plate. In this case, only the first guide plate 260 may be fixed to the supporting rod 220. This embodiment may be used, for example, when less than 50 wafers are to be cleaned. The distance between the first wafer W₁ and the guide plate 260 and the distance between the fiftieth wafer W₅₀ and the guide plate 260 are the same as the distance between each of the wafers W₁ to W₅₀.

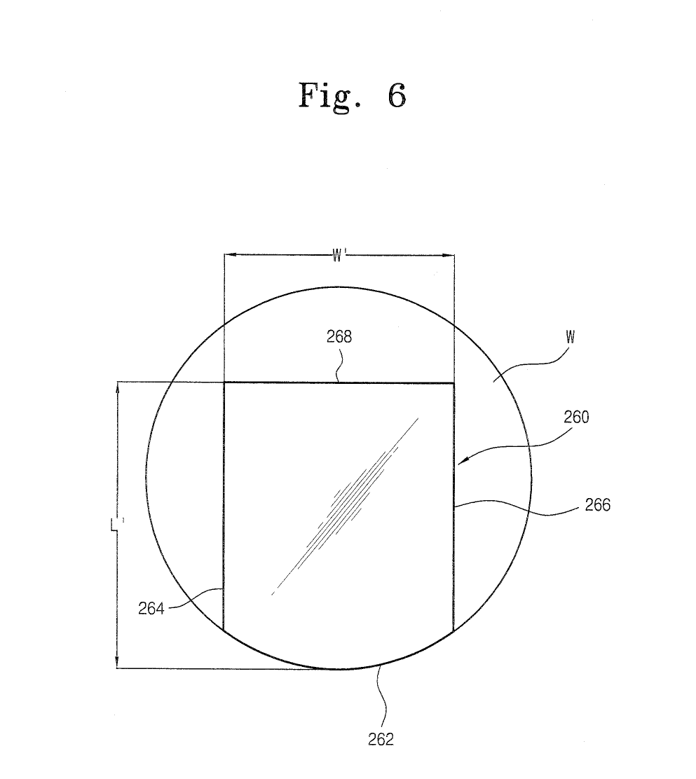

The guide plates 260 are shaped such that cleaning liquid injected to lower edges of the outer sides of the first wafer W₁ and the fiftieth wafer W₅₀ can be substantially vertically guided toward upper edges of the outer sides. FIG. 6 shows a guide plate 260 according to an embodiment of the invention. Referring to FIG. 6, the guide plate 260 has a flat-plate shape and is installed in an upright position. The guide plate 260 includes a rounded lower edge 262 for being disposed at ends of the supporting rods 220, a left edge 264 and a right edge 266 that are substantially vertically formed, and a horizontal upper edge 268. Since the left edge 264 and the right edge 266 of the guide plate 260 are substantially vertically formed in approximately parallel with each other, the guide plate 260 has a substantially uniform width W′ in a vertical direction. The vertical centerline of the guide plate 260 aligns with the vertical centerline of the wafers W₁ to W₅₀. The guide plate 260 is formed of a chemical-resistant material, such that the guide plate 260 can be protected from chemical solutions such as a sulfuric solution during a cleaning process. For example, the guide plate 260 can be formed of Teflon (trademark) such as Polytetrafluoroethylene (PTFE).

The width W′ of the guide plate 260 is sufficiently large such that cleaning liquid supplied between the guide plate 260 and the outermost wafer W₁ or W₅₀ can be prevented from deviating laterally from the guide plate 260. For example, the width W′ of the guide plate 260 may be equal to or larger than about half the diameter of the wafers W. Further, the guide plate 260 has a sufficiently large length L′ such that cleaning liquid supplied between the guide plate 260 and the outermost wafer W₁ or W₅₀ can flow to the upper edge of the wafer W₁ or W₅₀ along the outer side of the wafer W₁ or W₅₀. The length L′ of the guide plate 260 may be equal to or larger than about ¾ of the diameter of the wafers W. When the width W′ and length L′ of the guide plate 260 are extremely large, the size of the treating room 100 should be increased. Therefore, the width W′ and length L′ of the guide plate 260 may be equal to or smaller than the diameter of the wafers W₁ to W₅₀.

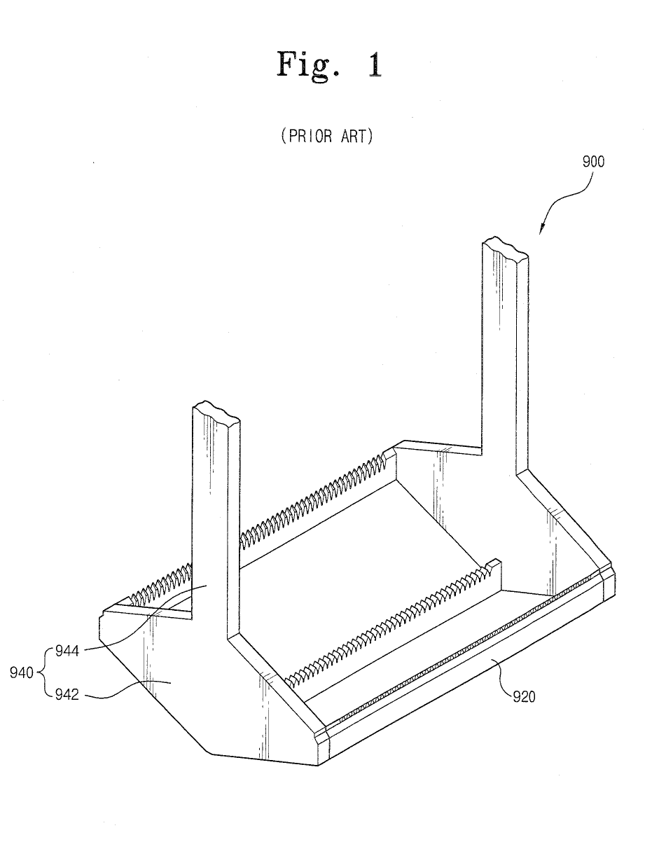

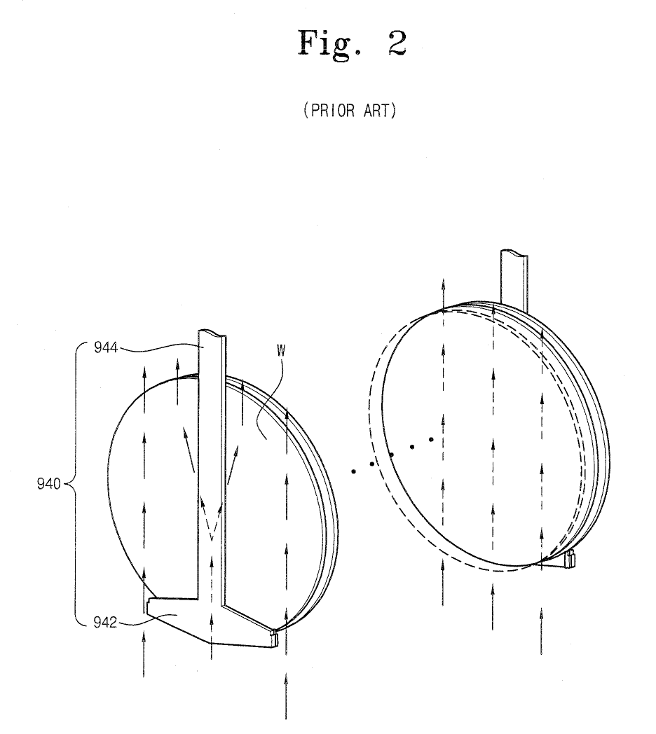

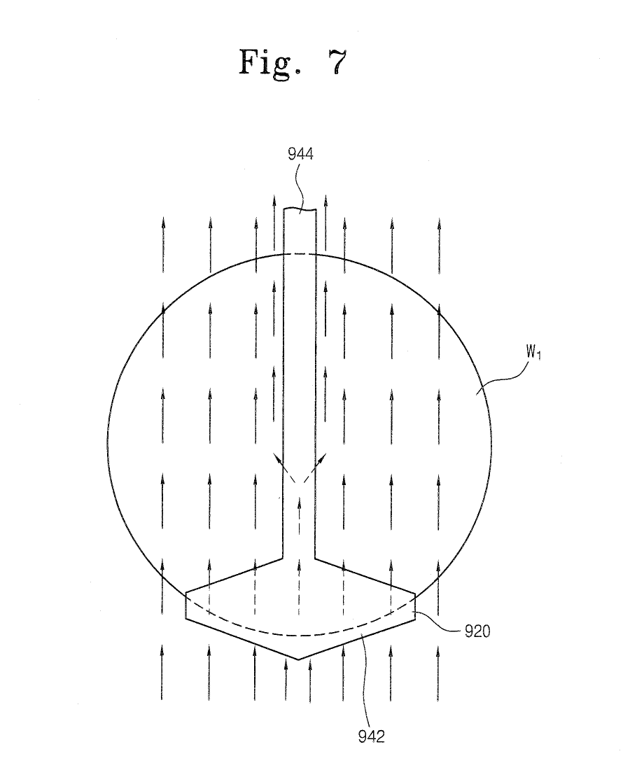

FIG. 7 illustrates paths of cleaning liquid flowing on the outer side of the first wafer W₁ when the supporter 900 of FIG. 1 is used without the guide plates 260. Cleaning liquid supplied between wafers (W) flows upward in a vertical direction while forming substantially uniform paths without outwardly diverging paths since the width of the wafers (W) is sufficiently large. However, as indicated by the dashed line, cleaning liquid flowing between the fixing rod 944 and the outer side of the first wafer W₁ diverges outwardly from the fixing rod 944 instead of flowing upward in a vertical direction because the fixing rod 944 is narrow.

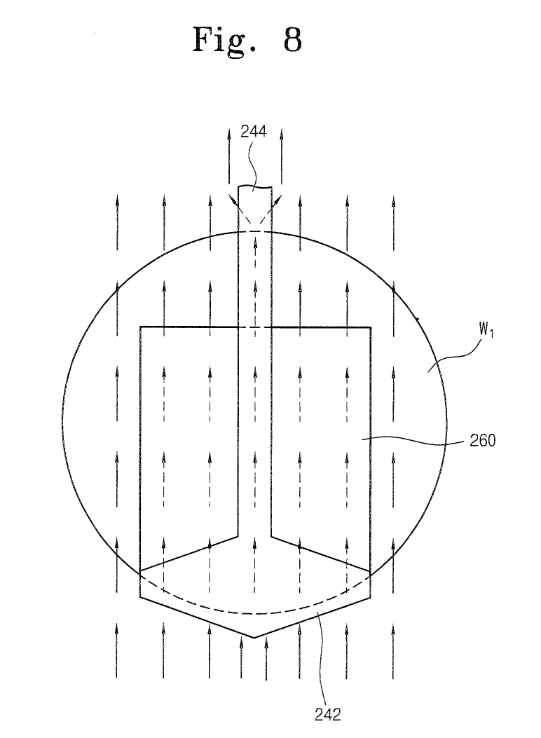

FIG. 8 illustrates paths of cleaning liquid flowing on the outer side of the first wafer W₁ when the supporter 200 having the guide plates 260 is used. Referring to FIG. 8, since the guide plates 260 have a sufficiently large width and length, cleaning liquid supplied between the guide plate 260 and the first wafer W₁ flows substantially vertically along the outer side of the first wafer W₁ to the upper edge of the first wafer W₁.

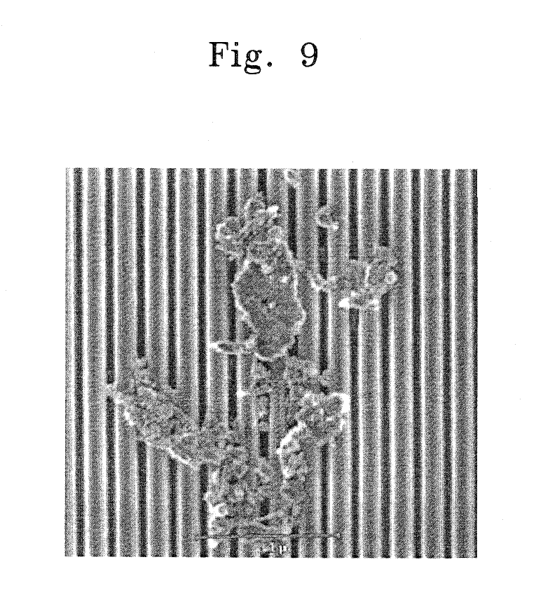

FIG. 9 shows defects (residuals) on an upper portion of an outermost wafer (W) when the supporter depicted in FIG. 7 is used. A sulfuric solution is used as cleaning solution to remove a photoresist from the wafer (W). Since the sulfuric solution is not sufficiently supplied to the upper portion of the wafer (W), the defects shown in FIG. 9 result. However, when the supporter 200 shown in FIG. 5 is used, such defects (residuals) are clearly removed.

In the above-described embodiments, the width of the guide plates 260 is substantially uniform in a length direction (a horizontal direction). However, the width of the guide plates 260 can vary in the length direction. Further, the guide plates 260 can have various shapes and sizes as long as the guide plates 260 allow cleaning liquid to flow substantially vertically from the lower edges to the upper edges of the wafers along the outer sides of the wafers.

Further, in the above-described embodiments, the fixing plates 240 are formed on both sides of the supporting rods 220, and the guide plates 260 are formed on both sides of the slots 222. However, only one fixing plate can be formed on one side of the supporting rods 220, and only one guide plate can be formed on one side of the slots 222.

A cleaning process using the substrate cleaning apparatus of FIG. 3 will now be briefly described. A chemical solution is filled in the inner tub 120. Next, about fifty wafers (W) are inserted into the slots 222 of the supporting rods 220 by a transfer robot (not shown). The chemical solution is continuously supplied to the wafers (W) from the nozzles 300. The chemical solution overflowing from the inner tub is received by the outer tub 140 and then discharged through the drain tube 190. The discharged chemical solution is recirculated for reuse. In addition, the cleaning process can continue while continuously supplying deionized water to the inner tub 120 through the nozzles 300 to replace the chemical solution.

Embodiments of the invention provide apparatuses for cleaning substrates, including: a treating room; a supporter disposed in the treating room during a process for supporting the substrates in a row in an upright position; and a liquid supplying member disposed in the treating room under the supporter for injecting cleaning liquid onto the substrates. The supporter includes: a plurality of supporting rods formed with slots for receiving edges of the substrates; a fixing plate connecting the supporting rods and fixing the supporter to the treating room during a process; and a guide plate mounted at a side of end slots of the slots of the supporting rods, the guide plate allowing the cleaning liquid injected under the substrates to substantially vertically flow along an outer surface of an outermost substrate inserted into the end slots. The guide plate may be shaped such that cleaning liquid injected toward a lower edge of the outermost substrate flows to an upper edge of the outermost substrate in a vertical direction.

In some embodiments, the guide plate has a width equal to or larger than about half the diameter of the substrates and a length equal to or larger than about ¾ of the diameter of the substrates. The width of the guide plate is substantially uniform in a lengthwise direction of the guide plate. A distance between the guide plate and the outermost substrate inserted into the end slots is equal to a distance between the each of the substrates inserted into the slots. The width and length of the guide plate are smaller than the diameter of the substrates. The supporter further includes: another fixing plate, the two fixing plates being respectively provided on both sides of the supporting rods; and another guide plate, the guide plates being respectively provided at both sides of outermost substrates of the substrates mounted on the supporting rods.

In other embodiments of the invention, there are provided methods for cleaning substrates arranged in a row in an upright position by supplying cleaning liquid to the substrate. The methods include providing a guide plate close to an outer surface of an outermost substrate of the arranged substrates to allow cleaning liquid injected toward a lower edge of the outermost substrate to substantially vertically flow along the outer surface of the outermost substrate in an upward direction. The methods further include providing another guide plate close to an outer surface of the other outermost substrate of the arranged substrates. The guide plate may be shaped such that cleaning liquid injected toward a lower edge of the outermost substrate flows to an upper edge of the outermost substrate in a vertical direction. The guide plate has a width equal to or larger than about ½ of the diameter of the substrates and a length approximately equal to or larger than about ¾ of the diameter of the substrates. The guide plate has a substantially uniform width in a length direction of the guide plate. The guide plate is fixedly mounted on a supporter supporting the substrates. The cleaning liquid is a chemical solution or rinsing liquid.

In still other embodiments of the invention, supporters for supporting a plurality of substrates in a row in an upright position are provided. The supporters include a plurality of supporting rods formed with slots for receiving edges of the substrates; and a guide plate mounted close to outermost slots of the slots of the supporting rods, the guide plate allowing cleaning liquid injected under the substrates to substantially vertically and upwardly flow along an outer surface of an outermost substrate inserted into the outermost slots. The guide plate can be shaped such that cleaning liquid injected toward a lower edge of the outermost substrate flows to an upper edge of the outermost substrate in a vertical direction. The guide plate has a width equal to or larger than about ½ of the diameter of the substrates and a length equal to or larger than about ⅔ of the diameter of the substrates. The width of the guide plate is substantially uniform in a length direction of the guide plate. A distance between the guide plate and the outermost substrate inserted into the outmost slots is equal to a distance between each of the substrates inserted into the slots. The supporters further include a fixing plate, the fixing plate including a connecting plate connecting ends of the supporting rods and an elongated fixing rod extending upward from the connecting plate.

As described above, according to the invention, the outermost wafers can be cleaned under the same conditions as the other wafers, so that cleaning uniformity can be improved.

Further, according to the invention, cleaning liquid is sufficiently supplied across the outer sides of the outermost wafers, so that the outermost wafers can be cleaned more efficiently.

The above-disclosed subject matter is to be considered illustrative, and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. An apparatus for cleaning substrates, comprising:
a treating room;
a supporter disposed in the treating room during a process, the supporter arranged and structured to support the substrates in a row in an upright position; and
a liquid supplying member disposed in the treating room under the supporter for injecting cleaning liquid onto the substrates,
wherein the supporter comprises:
a plurality of supporting rods including slots for receiving edges of the substrates, the supporting rods comprising a first end slot, a second end slot, and interior slots;
a fixing plate adapted to connect the supporting rods and adapted to fix the supporter to the treating room during a process; and
a first guide plate mounted at a side of the first end slot of the slots of the supporting rods, the first guide plate adapted to allow the cleaning liquid injected under the substrates to substantially vertically flow along an outer surface of an outermost substrate inserted into the first end slot.

2. The apparatus of claim 1, wherein the first guide plate has a width equal to or larger than about half the diameter of the substrates.

3. The apparatus of claim 1, wherein the first guide plate has a length equal to or larger than about ¾ of the diameter of the substrates.

4. The apparatus of claim 1, wherein the width and length of the first guide plate are smaller than the diameter of the substrates.

5. The apparatus of claim 1, wherein the width of the first guide plate is substantially uniform in a length direction of the first guide plate.

6. The apparatus of claim 1, wherein a distance between the first guide plate and the outermost substrate inserted into the first end slot is equal to a distance between each of the substrates inserted into the interior slots.

7. The apparatus of claim 1, wherein the first guide plate is shaped such that cleaning liquid injected toward a lower edge of the outermost substrate flows to an upper edge of the outermost substrate in a substantially vertical direction.

8. The apparatus of claim 1, wherein the supporter further comprises:
another fixing plate, the two fixing plates being respectively provided on both sides of the supporting rods; and
a second guide plate, the second guide plate being provided at the outermost side of the outermost substrate of the substrates mounted on the supporting rods, wherein the second guide plate is mounted at a side of the second end slot.

9. The apparatus of claim 1, wherein the first guide plate is fixedly mounted on the supporter.

10. A method for cleaning substrates arranged in a row in a substantially upright position by supplying cleaning liquid to the substrate, the method comprising providing a guide plate close to an outer surface of an outermost substrate of the substrates to allow cleaning liquid injected toward a lower edge of the outermost substrate to substantially vertically flow along the outer surface of the outermost substrate in an upward direction.

11. The method of claim 10, further comprising providing another guide plate close to an outer surface of the other outermost substrate of the arranged substrates.

12. The method of claim 10, wherein the guide plate has a width equal to or larger than about ½ of the diameter of the substrates and a length equal to or larger than about ¾ of the diameter of the substrates.

13. The method of claim 10, wherein the guide plate has a substantially uniform width in a length direction of the guide plate.

14. The method of claim 10, wherein the guide plate is fixedly mounted on a supporter supporting the substrates.

15. The method of claim 10, wherein the cleaning liquid is a chemical solution or rinsing liquid.

16. A supporter for supporting a plurality of substrates in a row in an upright position, the supporter comprising:
a plurality of supporting rods formed with slots for receiving edges of the substrates; and
a guide plate mounted close to outermost slots of the slots of the supporting rods, the guide plate adapted to allow cleaning liquid injected under the substrates to substantially vertically and upwardly flow along an outer surface of an outermost substrate inserted into the outermost slots.

17. The supporter of claim 16, wherein the guide plate has a width equal to or larger than about 1/2 of the diameter of the substrates and a length equal to or larger than about ⅔ of the diameter of the substrates.

18. The supporter of claim 16, wherein a distance between the guide plate and the outermost substrate inserted into the outermost slots is equal to a distance between the substrates inserted into interior slots.

19. The supporter of claim 16, further comprising a fixing plate, the fixing plate including a connecting plate connecting ends of the supporting rods and an elongated fixing rod extending upward from the connecting plate.

20. The supporter of claim 16, wherein the guide plate comprises polytetrafluoroethylene.
